(19) United States
(12) Patent Application Publication
(10) Pub. No.: US 2024/0373795 A1
(43) Pub. Date: Nov. 14, 2024

(54) HORTICULTURE TRAY

(71) Applicant: Blackmore Company, Inc., Belleville, MI (US)

(72) Inventor: Stefan JOHANSSON, Saline, MI (US)

(21) Appl. No.: 18/293,169

(22) PCT Filed: Jul. 29, 2022
(86) PCT No.: PCT/US2022/038848

§ 371 Date: Jan. 29, 2024

Related U.S. Application Data
(60) Provisional application No. 63/227,177, filed on Jul. 29, 2021.

(51) Int. Cl. A01G 9/029

(52) U.S. Cl. CPC A01G 9/0295; A01G 9/0293

(57) ABSTRACT

A horticulture tray comprising a plurality of growing cells configured to hold a plant. Each one of the plurality of growing cells includes spaced apart sidewalls defining air gap openings therebetween. The plurality of growing cells are arranged in rows and columns which are aligned. The horticulture tray is rectangular with an outer wall extending around a periphery of the horticulture tray. The plurality of growing cells are arranged such that sidewalls of horizontally adjacent growing cells are aligned and face each other to block direct line of sight between the horizontally adjacent growing cells to block root travel between the horizontally adjacent growing cells.

### CROSS-REFERENCE TO RELATED APPLICATION

This application claims the benefit of U.S. Provisional Application No. 63/227,177 filed on Jul. 29, 2021. The entire disclosure of the above application is incorporated herein by reference.

### FIELD

The present disclosure relates to a horticulture tray, such as a plant tray.

### BACKGROUND

Horticulture trays are often used to transport, store, and grow seeds and plants. While existing horticulture trays are suitable for their intended use, they are subject to improvement. The present disclosure advantageously includes horticulture trays that provide the advantages set forth herein, as well as numerous additional advantages.

### SUMMARY

The present disclosure includes a horticulture tray comprising a plurality of growing cells configured to hold a plant. Each one of the plurality of growing cells includes spaced apart sidewalls defining air gap openings therebetween.

### DRAWINGS

The drawings described herein are for illustrative purposes only of select embodiments and not all possible implementations, and are not intended to limit the scope of the present disclosure.

FIG. 1 is a perspective view of a top surface of a horticulture tray in accordance with the present disclosure;

FIG. 2 is a perspective view of a bottom surface of the horticulture tray of FIG. 1;

FIG. 3 is another perspective view of the bottom surface of the horticulture tray of FIG. 1;

FIG. 4 is another perspective view of the top surface of the horticulture tray of FIG. 1;

FIG. 5 is a cross-sectional view of the horticulture tray of FIG. 1;

FIG. 6 is another cross-sectional view of the horticulture tray of FIG. 1;

FIG. 7A is a top view of an exemplary growing cell of the horticulture tray of FIG. 1;

FIG. 7B is a perspective view of the growing cell of FIG. 7A;

FIG. 7C is a side view of the growing cell of FIG. 7A;

FIG. 7D is another side view of the growing cell of FIG. 7A rotated relative to FIG. 7C; and

FIG. 8. is an exemplary arrangement of the growing cells for the horticulture tray of FIG. 1.

### DETAILED DESCRIPTION

Example embodiments will now be described more fully with reference to the accompanying drawings.

Plants and trees require a branching and robust root structure to properly anchor them in the ground. Plants that do not have good root architecture, but rather have developed circular or spiral root structure, often referred to as girdling, may live for many years in the landscape before succumbing to the inherent problems caused by girdling. The economic damage caused by root system failure can be considerable.

Lack of proper root architecture or structure may lead to uprooting due to storms, wind, or even field saturation of the soil. Girdling can also lead to issues with mechanical harvesting (shaking) of nuts and fruits in commercial horticulture. Trees that fall over degrade the landscape, diminish the aesthetics of otherwise pleasant environments, cause property damage, and utility outages. In commercial harvesting, where trees are often shaken to make ripened fruit or nuts drop, trees without proper root architecture may be damaged or even be pulled from the ground due to the shaking, resulting in crop and financial loss. Large trees are not easily replaced in the landscape and commercial fruit or nut bearing trees normally require many years to mature before harvesting is again possible.

Horticulture trays allow plants to be grown in ideal and protected conditions before being transported to their permanent locations. However, the confines of horticulture trays can often cause root girdling that affect the plants long after transplanting into the landscape. Thus, there exists a need for horticulture trays that eliminate root girdling and promote proper root architecture.

Although there have been efforts to address the problems mentioned above, adequate solutions for providing the robust, lateral root architecture sought are not available. Existing production methods and containers fail to promote a generally linear root structure. A horticulture tray that can provide proper water management, active or passive, would also be desirable.

Prior horticulture trays are designed for use with loose fill growing media, such as loose soil, or soil-less mixes. These trays often attempt to mitigate girdling by including small holes in the sides or walls of the trays that allow roots that reach the holes to be air pruned. However, these holes can air prune only the roots that come in contact with them. Prior trays have also attempted to mitigate girdling by including vertical protrusions perpendicular to the sidewalls to prevent roots from following the sidewalls in a horizontal or circular direction. These vertical protrusions still fail to adequately prevent root girdling and promote proper root architecture by directing roots back toward the center of the tray causing a spiraling root structure.

Furthermore, stabilized growing media, sometimes referred to as stabilized growth plugs, or by trade name (such as Ellepots™ by The Blackmore Company), exist as a convenient, economical alternative to loose fill. Stabilized growth plugs can include soil, mulch, or peat moss wrapped in biodegradable paper, or can include other organic or synthetic substrate that retains its shape without a separate, supporting pot structure. These stabilized growth plugs can be planted directly into the ground making transplanting easier and more economical. As such, there exists a need for trays designed for growing and transporting plants in stabilized growth plugs, which overcome the limitations of conventional loose fill trays while promoting proper root architecture and water retention.

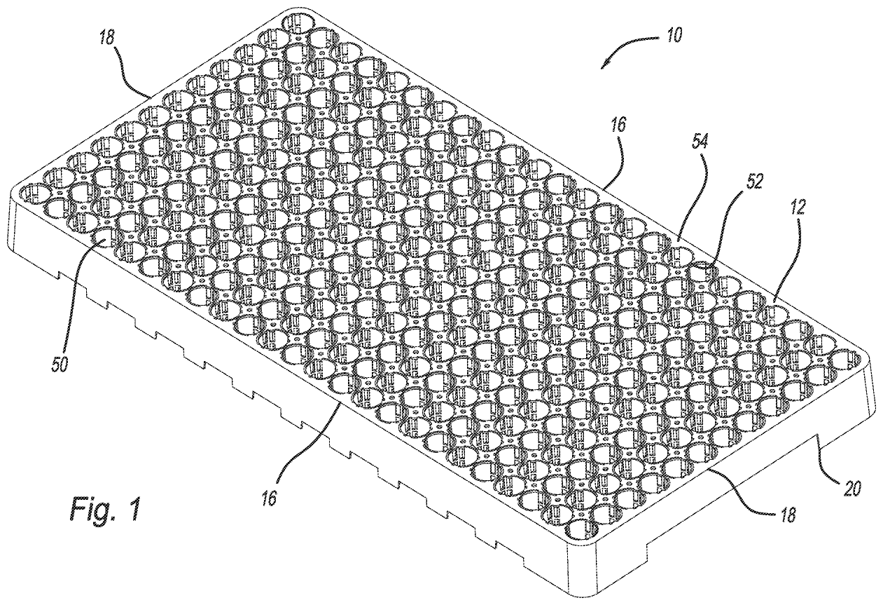

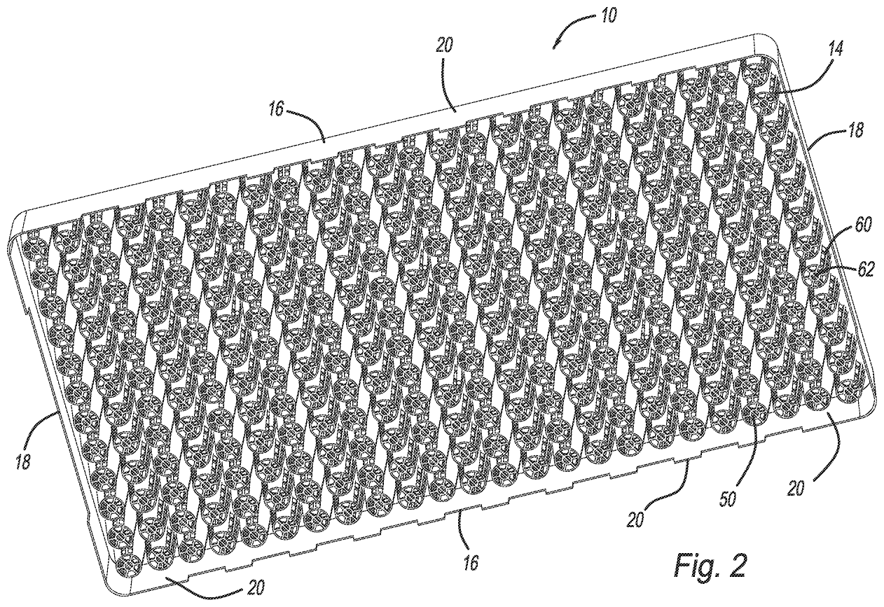

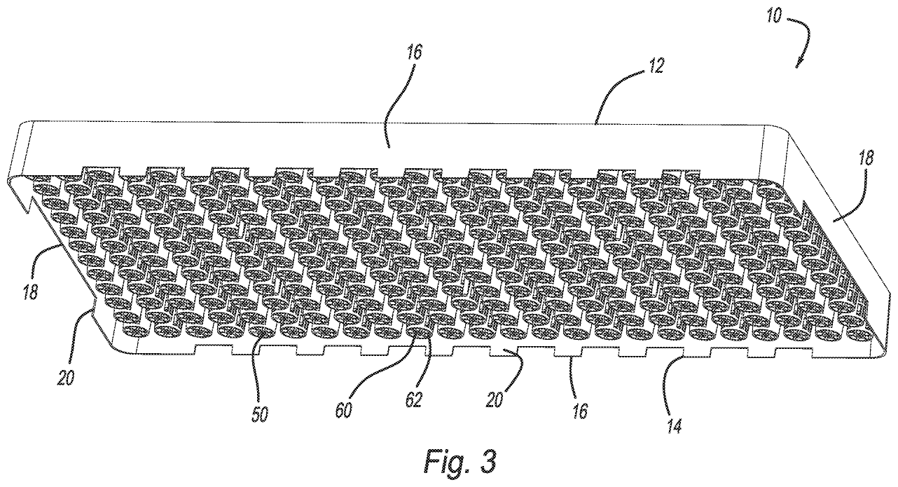

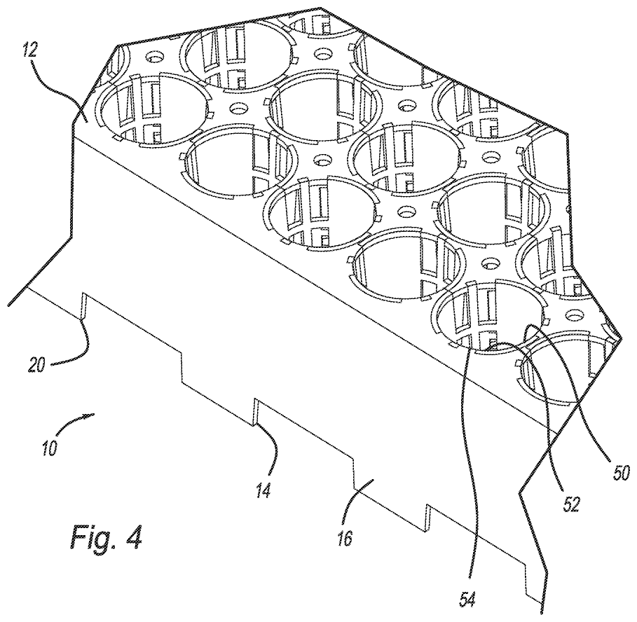

With initial reference to FIGS. 1-4, an exemplary horticulture tray according to the present disclosure is illustrated generally at reference numeral 10. The horticulture tray 10 is configured for growing and transporting plants, while preventing root spiraling or girdling, and promoting proper root architecture through air pruning, while also efficiently retaining water. The horticulture tray 10 may be made of any suitable material. For example, the tray 10 may generally be made of a substantially rigid material, such as a plastic or any other suitable polymer and can be formed using methods known in the art, such as vacuum thermoforming or injection molding, for example.

The horticulture tray 10 generally includes a top or upper surface 12 and a bottom or lower surface 14. The top surface 12 is opposite to the bottom surface 14. The tray 10 has two parallel side surfaces 16, and two parallel end surfaces 18. The tray 10 also includes an outer wall or skirt 20, which extends about an outer periphery of the tray 10. The tray 10 may have any suitable shape. For example and as illustrated throughout the drawings, the tray 10 may be rectangular. The tray 10 may be formed of any other suitable shape as well. For example, the tray 10 may be square.

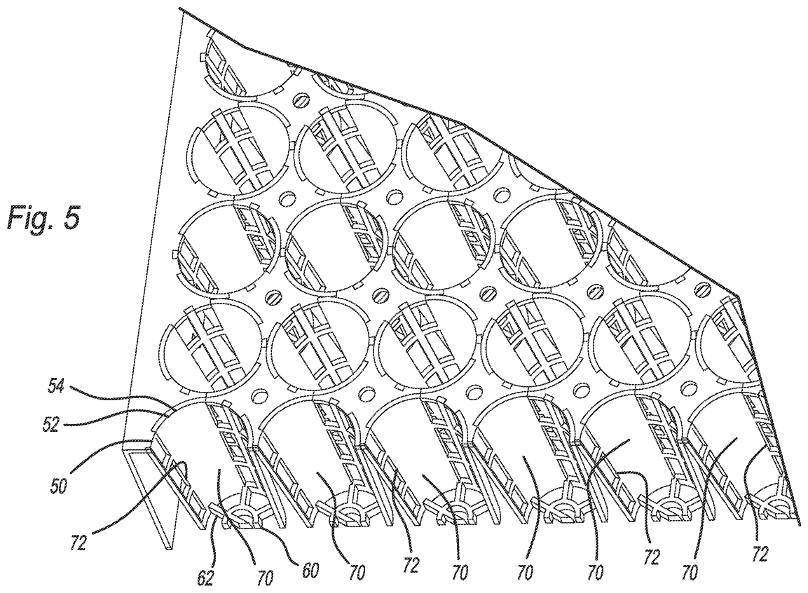

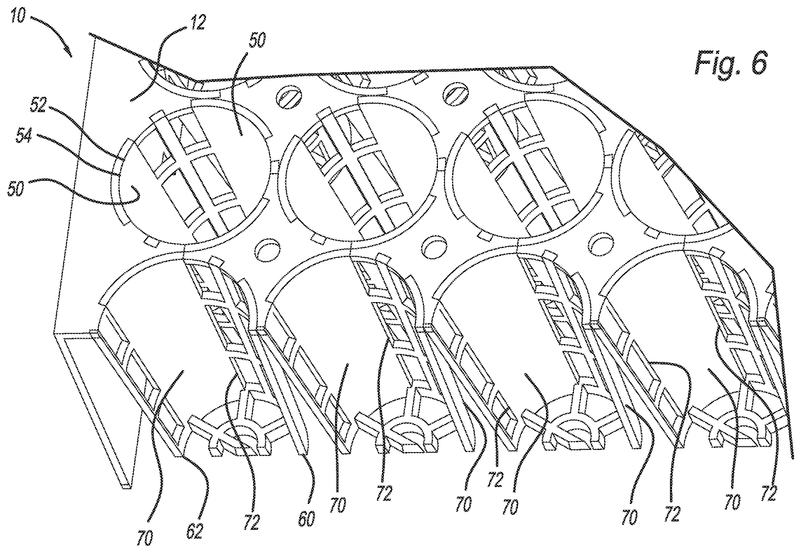

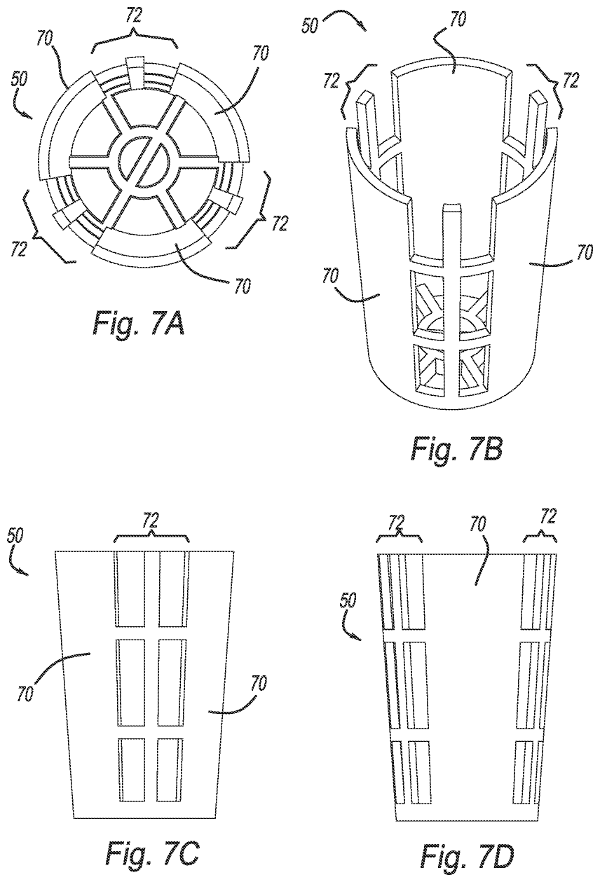

With continued reference to FIGS. 1-4, and additional reference to FIGS. 5-8, the horticulture tray 10 includes one or more growing cells 50. The cells 50 are a matrix of growing cells arranged in a plurality of rows and columns. Each one of the cells 50 includes a first aperture 52 defined at a first end 54, a second aperture 60 defined at a second end 62 that is opposite to the first end 54, and spaced apart sidewalls 70, which define air gap openings 72 therebetween. In the examples illustrated, each cell 50 has three spaced apart sidewalls 70 defining three air gap openings 72 to give each cell effectively six sides (three sidewalls 70 plus three openings 72). The cells 50 may have any other suitable number of sidewalls 70 spaced apart to define openings 72. Thus, each cell 50 may have any other suitable number of openings 72 other than three.

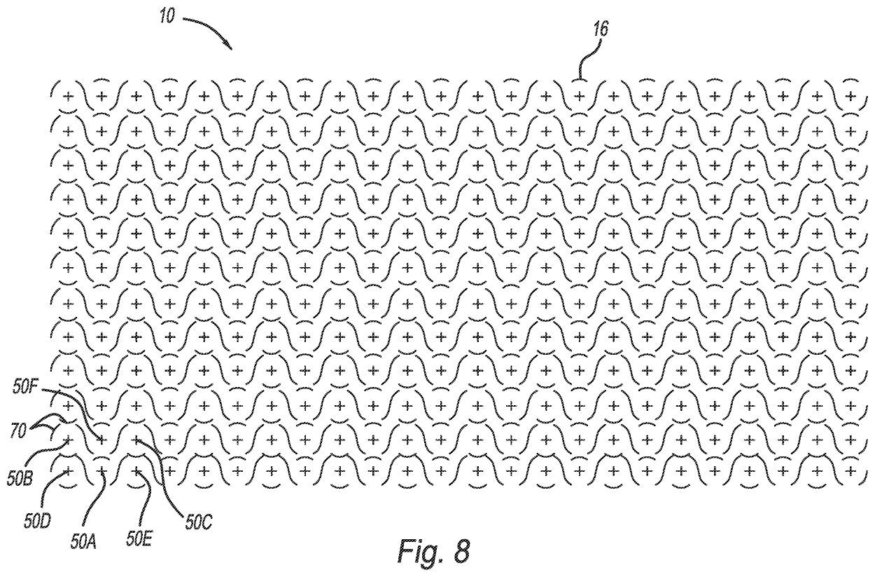

The present disclosure provides numerous advantages. For example, with respect to plant root development and pruning, the openings 72 provide open areas of air (oxygen) between the sidewalls 70 of the cells 50, which is important to the development of the roots and to keep the roots from circling. To prevent roots from “jumping,” or growing into an adjacent cell 50, adjacent cells 50 are rotated relative to each other so that there is no direct path for roots to jump from one cell 50 to an adjacent cell 50, except for diagonally arranged cells 50 because they are furthest apart from each other. Thus, only cells 50 that are arranged diagonal to each other have direct “line of sight” with respect to the openings 72 between the sidewalls 70 because cells 50 that are diagonal to each other are furthest apart with respect to adjacent pairs of cells 50. For example, and as illustrated in FIG. 8, cell 50A is diagonally adjacent to cell 50B and cell 50C. Thus, cell 50A is in direct line of sight with both cell 50B and cell 50C by way of alignment of the openings 72 of each one of cells 50A, 50B, and 50C. With respect to pairs of cells that are vertically adjacent or horizontally adjacent, the sidewalls 70 face each other to prevent roots from jumping horizontally or vertically. For example, cell 50A is horizontally adjacent to cells 50D and 50E, and cell 50A is vertically adjacent to cell 50F with respect to the orientation of FIG. 8.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. A horticulture tray comprising a plurality of growing cells configured to hold a plant, each one of the plurality of growing cells includes spaced apart sidewalls defining air gap openings therebetween.

2. The horticulture tray of claim 1, wherein the plurality of growing cells are arranged in rows and columns.

3. The horticulture tray of claim 2, wherein the rows are aligned and the columns are aligned.

4. The horticulture tray of claim 1, wherein the horticulture tray is rectangular.

5. The horticulture tray of claim 1, further comprising an outer wall extending around a periphery of the horticulture tray.

6. The horticulture tray of claim 1, wherein each one of the plurality of growing cells includes a first aperture defined at a first end and a second aperture defined at a second end that is opposite to the first end.

7. The horticulture tray of claim 6, wherein each one of the plurality of growing cells includes sidewalls extending from the first aperture to the second aperture, the sidewalls are spaced apart to define air gaps therebetween.

8. The horticulture tray of claim 1, wherein each one of the plurality of growing cells includes spaced apart sidewalls defining air gap openings therebetween.

9. The horticulture tray of claim 8, wherein the air gaps extend along an entire depth of the plurality of growing cells.

10. The horticulture tray of claim 8, wherein the plurality of growing cells are arranged such that air gap openings of diagonally adjacent growing cells are aligned to provide direct line of sight between the diagonally adjacent growing cells.

11. The horticulture tray of claim 10, wherein the plurality of growing cells are arranged such that sidewalls of vertically adjacent growing cells are aligned and face each other to block direct line of sight between the vertically adjacent growing cells to block root travel between the vertically adjacent growing cells.

12. The horticulture tray of claim 11, wherein the plurality of growing cells are arranged such that sidewalls of horizontally adjacent growing cells are aligned and face each other to block direct line of sight between the horizontally adjacent growing cells to block root travel between the horizontally adjacent growing cells.
